(19) United States
(12) Patent Application Publication
(10) Pub. No.: US 2017/0295509 A1
(43) Pub. Date: Oct. 12, 2017

(54) METHOD AND APPARATUS FOR DETERMINING MEASUREMENT PERIOD IN WIRELESS COMMUNICATION SYSTEM

(71) Applicant: LG ELECTRONICS INC., Seoul (KR)

(72) Inventors: Youngdae LEE, Seoul (KR); Seungjune YI, Seoul (KR); Sunghoon JUNG, Seoul (KR); Sangwon KIM, Seoul (KR)

(73) Assignee: LG ELECTRONICS INC., Seoul (KR)

(21) Appl. No.: 15/107,033

(22) PCT Filed: Jan. 29, 2015
(86) PCT No.: PCT/KR2015/000975

§ 371 Date: Jun. 21, 2016

Related U.S. Application Data
(60) Provisional application No. 61/932,800, filed on Jan. 29, 2014.

(51) Int. Cl. H04W 24/10; H04W 4/06

(52) U.S. Cl. CPC H04W 24/10; H04W 4/06; H04L 12/189

(57) ABSTRACT

A method and apparatus for determining a measurement period in a wireless communication system is provided. A user equipment (UE) sets start of the measurement period to one of beginning of a period of a broadcast/multicast control channel or beginning of a scheduling period for the broadcast/multicast channel, which is one of a multicast control channel (MCCH) modification period, a MCCH repetition period, a broadcast control channel (BCCH) modification period, or a multicast channel (MCH) scheduling period (MSP). The UE performs, at a radio link control (RLC) layer or a media access control (MAC) layer, measurement from the start of the measurement period.

### TECHNICAL FIELD

The present invention relates to wireless communications, and more particularly, to a method and apparatus for determining a measurement period in a wireless communication system.

### BACKGROUND ART

Universal mobile telecommunications system (UMTS) is a 3rd generation (3G) asynchronous mobile communication system operating in wideband code division multiple access (WCDMA) based on European systems, global system for mobile communications (GSM) and general packet radio services (GPRS). A long-term evolution (LTE) of UMTS is under discussion by the 3rd generation partnership project (3GPP) that standardized UMTS.

The 3GPP LTE is a technology for enabling high-speed packet communications. Many schemes have been proposed for the LTE objective including those that aim to reduce user and provider costs, improve service quality, and expand and improve coverage and system capacity. The 3GPP LTE requires reduced cost per bit, increased service availability, flexible use of a frequency band, a simple structure, an open interface, and adequate power consumption of a terminal as an upper-level requirement.

The 3GPP LTE can provide a multimedia broadcast multicast service (MBMS) service. The MBMS is a service which simultaneously transmits data packets to multiple users. If a specific level of users exists in the same cell, the respective users can be allowed to share necessary resources so that the plurality of users can receive the same multimedia data, thereby increasing resource efficiency. In addition, a multimedia service can be used with a low cost from the perspective of users.

A user equipment (UE) may measure MBMS service quality for a certain measurement period. However, it is not clear how the UE determines the start/stop of the measurement period. Accordingly, a method for determining a measurement period for MBMS may be required.

### SUMMARY OF INVENTION

### Technical Problem

The present invention provides a method and apparatus for determining a measurement period in a wireless communication system. The present invention provides a method for determining a measurement period for multimedia broadcast multicast service (MBMS) quality of service (QoS) verification.

### Solution to Problem

In an aspect, a method for determining, by a user equipment (UE), a measurement period in a wireless communication system is provided. The method includes setting, by the UE, start of the measurement period to one of beginning of a period of a broadcast/multicast control channel or beginning of a scheduling period for the broadcast/multicast channel, and performing, by a radio link control (RLC) layer or a media access control (MAC) layer of the UE, measurement from the start of the measurement period.

In another aspect, a user equipment (UE) configured to determine a measurement period in a wireless communication system is provided. The UE includes a radio frequency (RF) unit configured to transmit or receive a radio signal, and a processor coupled to the RF unit, and configured to set start of the measurement period to one of beginning of a period of a broadcast/multicast control channel or beginning of a scheduling period for the broadcast/multicast channel, and perform, at a radio link control (RLC) layer or a media access control (MAC) layer of the UE, measurement from the start of the measurement period.

### Advantageous Effects of Invention

A measurement period for MBMS can be determined.

### BRIEF DESCRIPTION OF DRAWINGS

FIG. 1 shows LTE system architecture.

FIG. 2 shows a block diagram of architecture of a typical E-UTRAN and a typical EPC.

FIG. 3 shows a block diagram of a user plane protocol stack of an LTE system.

FIG. 4 shows a block diagram of a control plane protocol stack of an LTE system.

FIG. 5 shows an example of a physical channel structure.

FIG. 6 shows MBMS definitions.

FIG. 7 shows change of MCCH information.

FIG. 8 shows a MCCH information acquisition procedure.

FIG. 9 shows an MBMS interest indication procedure.

FIG. 10 shows an example of a method for determining a measurement period according to an embodiment of the present invention.

FIG. 11 shows a wireless communication system to implement an embodiment of the present invention.

### MODE FOR THE INVENTION

The technology described below can be used in various wireless communication systems such as code division multiple access (CDMA), frequency division multiple access (FDMA), time division multiple access (TDMA), orthogonal frequency division multiple access (OFDMA), single carrier frequency division multiple access (SC-FDMA), etc. The CDMA can be implemented with a radio technology such as universal terrestrial radio access (UTRA) or CDMA-2000. The TDMA can be implemented with a radio technology such as global system for mobile communications (GSM)/general packet ratio service (GPRS)/enhanced data rate for GSM evolution (EDGE). The OFDMA can be implemented with a radio technology such as institute of electrical and electronics engineers (IEEE) 802.11 (Wi-Fi), IEEE 802.16 (WiMAX), IEEE 802-20, evolved UTRA (E-UTRA), etc. IEEE 802.16m is an evolution of IEEE 802.16e, and provides backward compatibility with an IEEE 802.16-based system. The UTRA is a part of a universal mobile telecommunication system (UMTS). 3rd generation partnership project (3GPP) long term evolution (LTE) is a part of an evolved UMTS (E-UMTS) using the E-UTRA. The 3GPP LTE uses the OFDMA in downlink and uses the SC-FDMA in uplink LTE-advance (LTE-A) is an evolution of the 3GPP LTE.

For clarity, the following description will focus on the LTE-A. However, technical features of the present invention are not limited thereto.

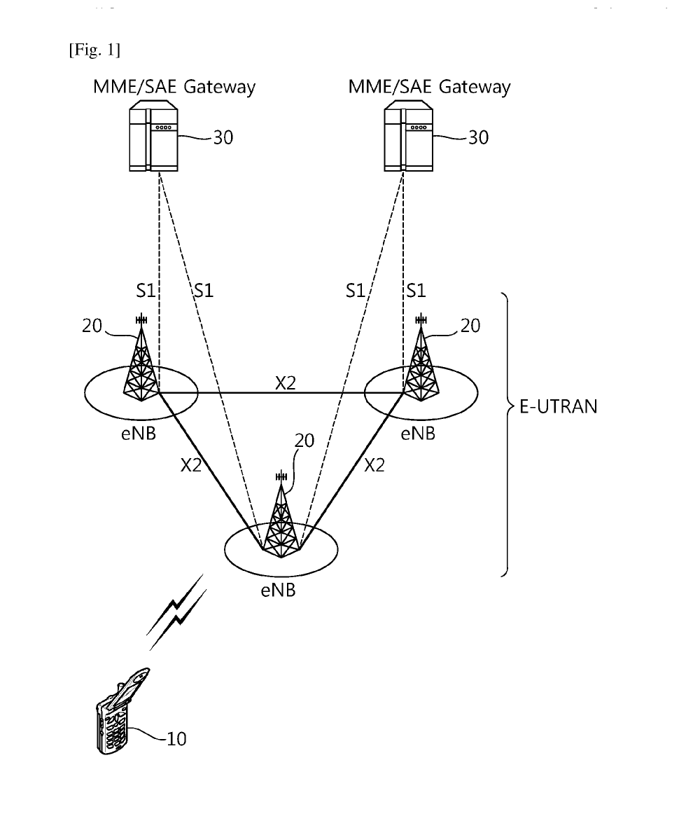

FIG. 1 shows LTE system architecture. The communication network is widely deployed to provide a variety of communication services such as voice over internet protocol (VoIP) through IMS and packet data.

Referring to FIG. 1, the LTE system architecture includes one or more user equipment (UE; 10), an evolved-UMTS terrestrial radio access network (E-UTRAN) and an evolved packet core (EPC). The UE 10 refers to a communication equipment carried by a user. The UE 10 may be fixed or mobile, and may be referred to as another terminology, such as a mobile station (MS), a user terminal (UT), a subscriber station (SS), a wireless device, etc.

The E-UTRAN includes one or more evolved node-B (eNB) 20, and a plurality of UEs may be located in one cell. The eNB 20 provides an end point of a control plane and a user plane to the UE 10. The eNB 20 is generally a fixed station that communicates with the UE 10 and may be referred to as another terminology, such as a base station (BS), an access point, etc. One eNB 20 may be deployed per cell.

Hereinafter, a downlink (DL) denotes communication from the eNB 20 to the UE 10, and an uplink (UL) denotes communication from the UE 10 to the eNB 20. In the DL, a transmitter may be a part of the eNB 20, and a receiver may be a part of the UE 10. In the UL, the transmitter may be a part of the UE 10, and the receiver may be a part of the eNB 20.

The EPC includes a mobility management entity (MME) and a system architecture evolution (SAE) gateway (S-GW). The MME/S-GW 30 may be positioned at the end of the network and connected to an external network. For clarity, MME/S-GW 30 will be referred to herein simply as a “gateway,” but it is understood that this entity includes both the MME and S-GW.

The MME provides various functions including non-access stratum (NAS) signaling to eNBs 20, NAS signaling security, access stratum (AS) security control, inter core network (CN) node signaling for mobility between 3GPP access networks, idle mode UE reachability (including control and execution of paging retransmission), tracking area list management (for UE in idle and active mode), packet data network (PDN) gateway (P-GW) and S-GW selection, MME selection for handovers with MME change, serving GPRS support node (SGSN) selection for handovers to 2G or 3G 3GPP access networks, roaming, authentication, bearer management functions including dedicated bearer establishment, support for public warning system (PWS) (which includes earthquake and tsunami warning system (ETWS) and commercial mobile alert system (CMAS)) message transmission. The S-GW host provides assorted functions including per-user based packet filtering (by e.g., deep packet inspection), lawful interception, UE Internet protocol (IP) address allocation, transport level packet marking in the DL, UL and DL service level charging, gating and rate enforcement, DL rate enforcement based on access point name aggregate maximum bit rate (APN-AMBR).

Interfaces for transmitting user traffic or control traffic may be used. The UE 10 is connected to the eNB 20 via a Uu interface. The eNBs 20 are connected to each other via an X2 interface. Neighboring eNBs may have a meshed network structure that has the X2 interface. A plurality of nodes may be connected between the eNB 20 and the gateway 30 via an S1 interface.

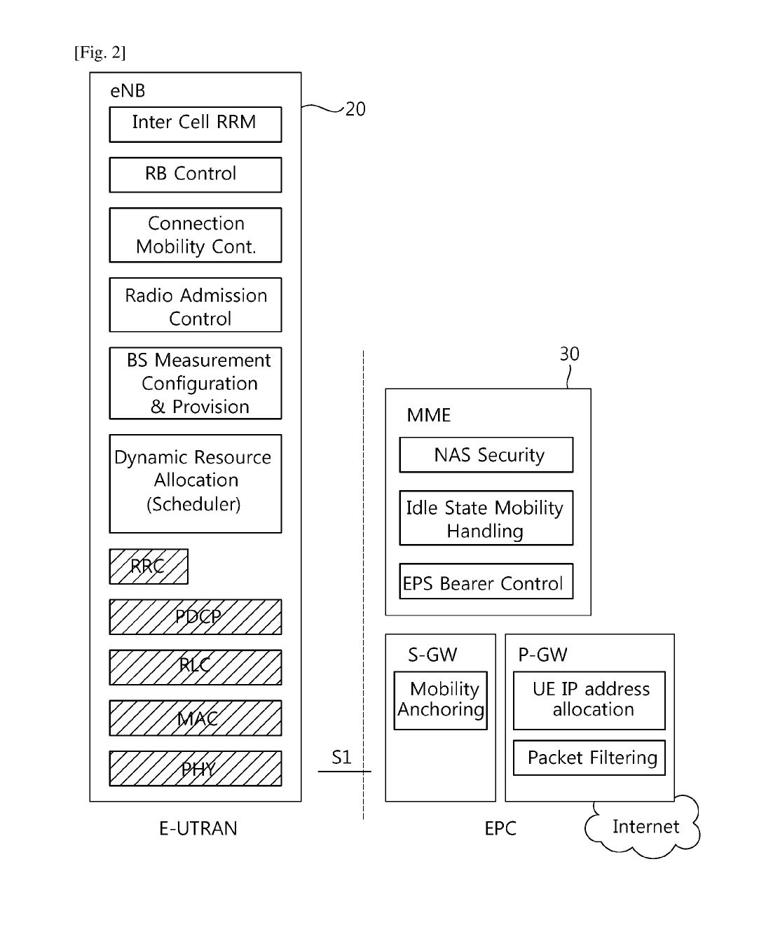

FIG. 2 shows a block diagram of architecture of a typical E-UTRAN and a typical EPC. Referring to FIG. 2, the eNB 20 may perform functions of selection for gateway 30, routing toward the gateway 30 during a radio resource control (RRC) activation, scheduling and transmitting of paging messages, scheduling and transmitting of broadcast channel (BCH) information, dynamic allocation of resources to the UEs 10 in both UL and DL, configuration and provisioning of eNB measurements, radio bearer control, radio admission control (RAC), and connection mobility control in LTE_ACTIVE state. In the EPC, and as noted above, gateway 30 may perform functions of paging origination, LTE_IDLE state management, ciphering of the user plane, SAE bearer control, and ciphering and integrity protection of NAS signaling.

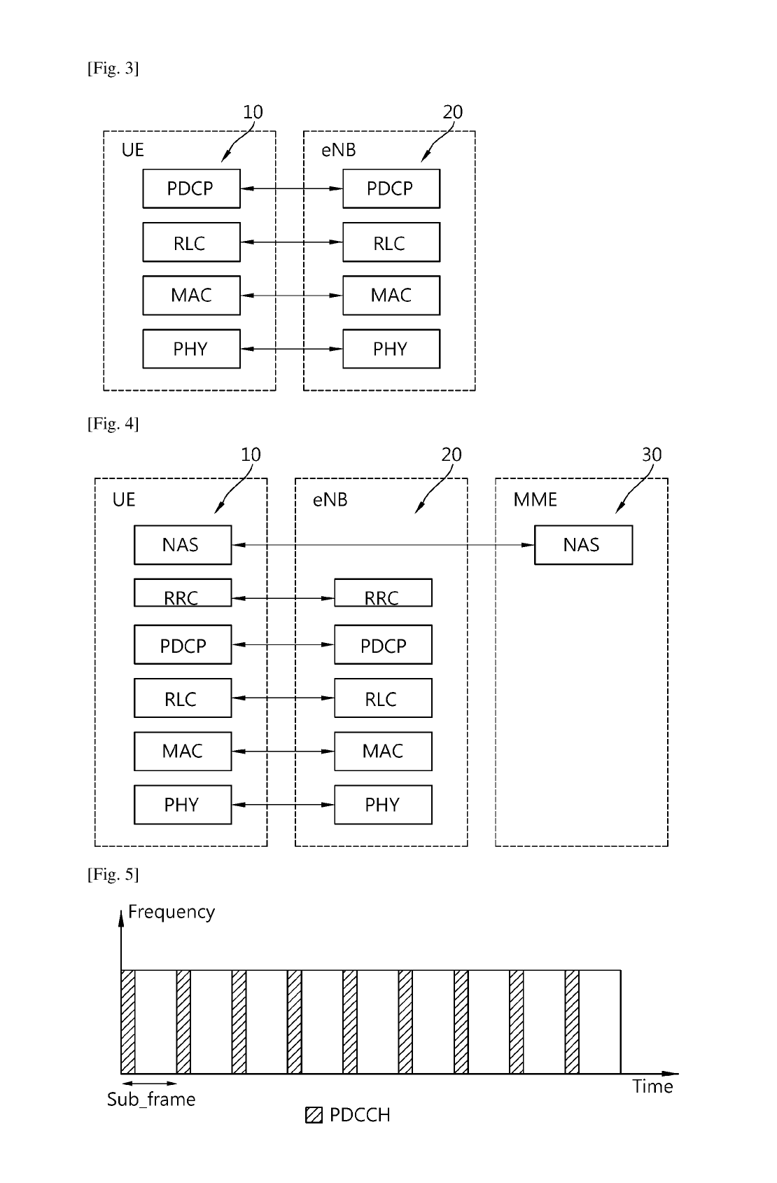

FIG. 3 shows a block diagram of a user plane protocol stack of an LTE system. FIG. 4 shows a block diagram of a control plane protocol stack of an LTE system. Layers of a radio interface protocol between the UE and the E-UTRAN may be classified into a first layer (L1), a second layer (L2), and a third layer (L3) based on the lower three layers of the open system interconnection (OSI) model that is well-known in the communication system.

A physical (PHY) layer belongs to the L1. The PHY layer provides a higher layer with an information transfer service through a physical channel. The PHY layer is connected to a medium access control (MAC) layer, which is a higher layer of the PHY layer, through a transport channel. A physical channel is mapped to the transport channel. Data between the MAC layer and the PHY layer is transferred through the transport channel. Between different PHY layers, i.e. between a PHY layer of a transmission side and a PHY layer of a reception side, data is transferred via the physical channel.

A MAC layer, a radio link control (RLC) layer, and a packet data convergence protocol (PDCP) layer belong to the L2. The MAC layer provides services to the RLC layer, which is a higher layer of the MAC layer, via a logical channel. The MAC layer provides data transfer services on logical channels. The RLC layer supports the transmission of data with reliability. Meanwhile, a function of the RLC layer may be implemented with a functional block inside the MAC layer. In this case, the RLC layer may not exist. The PDCP layer provides a function of header compression function that reduces unnecessary control information such that data being transmitted by employing IP packets, such as IPv4 or IPv6, can be efficiently transmitted over a radio interface that has a relatively small bandwidth.

A radio resource control (RRC) layer belongs to the L3. The RLC layer is located at the lowest portion of the L3, and is only defined in the control plane. The RRC layer controls logical channels, transport channels, and physical channels in relation to the configuration, reconfiguration, and release of radio bearers (RBs). The RB signifies a service provided the L2 for data transmission between the UE and E-UTRAN.

Referring to FIG. 3, the RLC and MAC layers (terminated in the eNB on the network side) may perform functions such as scheduling, automatic repeat request (ARQ), and hybrid ARQ (HARM). The PDCP layer (terminated in the eNB on the network side) may perform the user plane functions such as header compression, integrity protection, and ciphering.

Referring to FIG. 4, the RLC and MAC layers (terminated in the eNB on the network side) may perform the same functions for the control plane. The RRC layer (terminated in the eNB on the network side) may perform functions such as broadcasting, paging, RRC connection management, RB control, mobility functions, and UE measurement reporting and controlling. The NAS control protocol (terminated in the MME of gateway on the network side) may perform functions such as a SAE bearer management, authentication, LTE_IDLE mobility handling, paging origination in LTE_IDLE, and security control for the signaling between the gateway and UE.

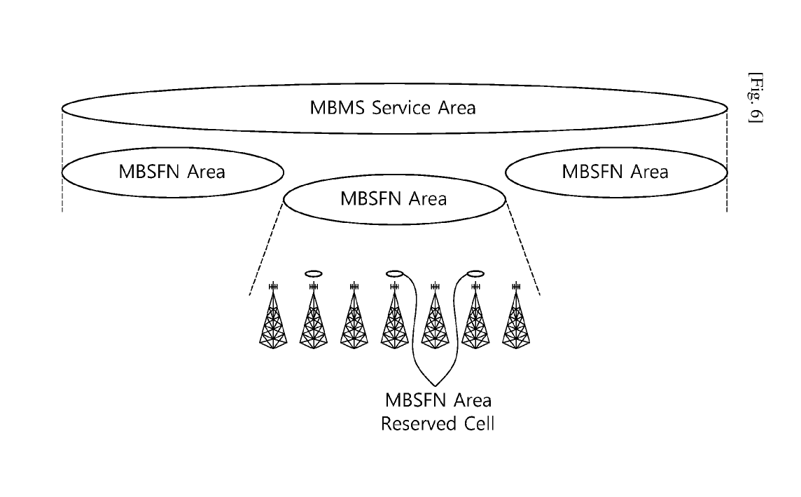

FIG. 5 shows an example of a physical channel structure. A physical channel transfers signaling and data between PHY layer of the UE and eNB with a radio resource. A physical channel consists of a plurality of subframes in time domain and a plurality of subcarriers in frequency domain. One subframe, which is 1 ms, consists of a plurality of symbols in the time domain. Specific symbol(s) of the subframe, such as the first symbol of the subframe, may be used for a physical downlink control channel (PDCCH). The PDCCH carries dynamic allocated resources, such as a physical resource block (PRB) and modulation and coding scheme (MCS).

A DL transport channel includes a broadcast channel (BCH) used for transmitting system information, a paging channel (PCH) used for paging a UE, a downlink shared channel (DL-SCH) used for transmitting user traffic or control signals, a multicast channel (MCH) used for multicast or broadcast service transmission. The DL-SCH supports HARQ, dynamic link adaptation by varying the modulation, coding and transmit power, and both dynamic and semi-static resource allocation. The DL-SCH also may enable broadcast in the entire cell and the use of beamforming.

A UL transport channel includes a random access channel (RACH) normally used for initial access to a cell, a uplink shared channel (UL-SCH) for transmitting user traffic or control signals, etc. The UL-SCH supports HARQ and dynamic link adaptation by varying the transmit power and potentially modulation and coding. The UL-SCH also may enable the use of beamforming.

The logical channels are classified into control channels for transferring control plane information and traffic channels for transferring user plane information, according to a type of transmitted information. That is, a set of logical channel types is defined for different data transfer services offered by the MAC layer.

The control channels are used for transfer of control plane information only. The control channels provided by the MAC layer include a broadcast control channel (BCCH), a paging control channel (PCCH), a common control channel (CCCH), a multicast control channel (MCCH) and a dedicated control channel (DCCH). The BCCH is a downlink channel for broadcasting system control information. The PCCH is a downlink channel that transfers paging information and is used when the network does not know the location cell of a UE. The CCCH is used by UEs having no RRC connection with the network. The MCCH is a point-to-multipoint downlink channel used for transmitting multimedia broadcast multicast services (MBMS) control information from the network to a UE. The DCCH is a point-to-point bi-directional channel used by UEs having an RRC connection that transmits dedicated control information between a UE and the network.

Traffic channels are used for the transfer of user plane information only. The traffic channels provided by the MAC layer include a dedicated traffic channel (DTCH) and a multicast traffic channel (MTCH). The DTCH is a point-to-point channel, dedicated to one UE for the transfer of user information and can exist in both uplink and downlink. The MTCH is a point-to-multipoint downlink channel for transmitting traffic data from the network to the UE.

Uplink connections between logical channels and transport channels include the DCCH that can be mapped to the UL-SCH, the DTCH that can be mapped to the UL-SCH and the CCCH that can be mapped to the UL-SCH. Downlink connections between logical channels and transport channels include the BCCH that can be mapped to the BCH or DL-SCH, the PCCH that can be mapped to the PCH, the DCCH that can be mapped to the DL-SCH, and the DTCH that can be mapped to the DL-SCH, the MCCH that can be mapped to the MCH, and the MTCH that can be mapped to the MCH.

An RRC state indicates whether an RRC layer of the UE is logically connected to an RRC layer of the E-UTRAN. The RRC state may be divided into two different states such as an RRC idle state (RRC_IDLE) and an RRC connected state (RRC_CONNECTED). In RRC_IDLE, the UE may receive broadcasts of system information and paging information while the UE specifies a discontinuous reception (DRX) configured by NAS, and the UE has been allocated an identification (ID) which uniquely identifies the UE in a tracking area and may perform public land mobile network (PLMN) selection and cell re-selection. Also, in RRC_IDLE, no RRC context is stored in the eNB.

In RRC_CONNECTED, the UE has an E-UTRAN RRC connection and a context in the E-UTRAN, such that transmitting and/or receiving data to/from the eNB becomes possible. Also, the UE can report channel quality information and feedback information to the eNB. In RRC_CONNECTED, the E-UTRAN knows the cell to which the UE belongs. Therefore, the network can transmit and/or receive data to/from UE, the network can control mobility (handover and inter-radio access technologies (RAT) cell change order to GSM EDGE radio access network (GERAN) with network assisted cell change (NACC)) of the UE, and the network can perform cell measurements for a neighboring cell.

In RRC_IDLE, the UE specifies the paging DRX cycle. Specifically, the UE monitors a paging signal at a specific paging occasion of every UE specific paging DRX cycle. The paging occasion is a time interval during which a paging signal is transmitted. The UE has its own paging occasion. A paging message is transmitted over all cells belonging to the same tracking area. If the UE moves from one tracking area (TA) to another TA, the UE will send a tracking area update (TAU) message to the network to update its location.

Multimedia broadcast multicast services (MBMS) are described. It may be referred to Section 15 of 3GPP TS 36.300 V11.7.0 (2013-09) and Section 5.8 of 3GPP TS 36.331 V11.5.0 (2013-09).

FIG. 6 shows MBMS definitions. For MBMS, the following definitions may be introduced.
Multicast-broadcast single-frequency network (MBSFN) synchronization area: This is an area of the network where all eNBs can be synchronized and perform MBSFN transmissions. MBSFN synchronization areas are capable of supporting one or more MBSFN areas. On a given frequency layer, an eNB can only belong to one MBSFN synchronization area. MBSFN synchronization areas are independent from the definition of MBMS service areas.
MBSFN transmission or a transmission in MBSFN mode: This is a simulcast transmission technique realized by transmission of identical waveforms at the same time from multiple cells. An MBSFN transmission from multiple cells within the MBSFN area is seen as a single transmission by a UE.
MBSFN area: an MBSFN area consists of a group of cells within an MBSFN synchronization area of a network, which are coordinated to achieve an MBSFN transmission. Except for the MBSFN area reserved cells, all cells within an MBSFN area contribute to the MBSFN transmission and advertise its availability. The UE may only need to consider a subset of the MBSFN areas that are configured, i.e., when it knows which MBSFN area applies for the service(s) it is interested to receive.
MBSFN area reserved cell: This is a cell within a MBSFN area which does not contribute to the MBSFN transmission. The cell may be allowed to transmit for other services but at restricted power on the resource allocated for the MBSFN transmission.
Synchronization sequence: Each synchronization protocol data unit (SYNC PDU) contains a time stamp which indicates the start time of the synchronization sequence. For an MBMS service, each synchronization sequence has the same duration which is configured in the broadcast and multicast service center (BM-SC) and the multicell/multicast coordination entity (MCE).
Synchronization period: The synchronization period provides the time reference for the indication of the start time of each synchronization sequence. The time stamp which is provided in each SYNC PDU is a relative value which refers to the start time of the synchronization period. The duration of the synchronization period is configurable.

In E-UTRAN, MBMS can be provided with single frequency network mode of operation (MBSFN) only on a frequency layer shared with non-MBMS services (set of cells supporting both unicast and MBMS transmissions, i.e., set of “MBMS/Unicast-mixed cells”). MBMS reception is possible for UEs in RRC_CONNECTED or RRC_IDLE states. Whenever receiving MBMS services, a user shall be notified of an incoming call, and originating calls shall be possible. Robust header compression (ROHC) is not supported for MBMS. Relay nodes (RNs) do not support MBMS.

Multi-cell transmission of MBMS is characterized by:
Synchronous transmission of MBMS within its MBSFN area;
Combining of MBMS transmission from multiple cells is supported;
Scheduling of each MCH is done by the MCE;
A single transmission is used for MCH (i.e. neither blind HARQ repetitions nor RLC quick repeat);
A single transport block (TB) is used per TTI for MCH transmission, that TB uses all the MBSFN resources in that subframe;
MTCH and MCCH can be multiplexed on the same MCH and are mapped on MCH for point-to-multipoint (PTM) transmission;
MTCH and MCCH use the RLC unacknowledged mode (UM);
The MAC subheader indicates the logical channel ID (LCID) for MTCH and MCCH;
The MBSFN synchronization area, the MBSFN area, and the MBSFN cells are semi-statically configured, e.g. by O&M;
MBSFN areas are static, unless changed by O&M (i.e. no dynamic change of areas);

Multiple MBMS services can be mapped to the same MCH and one MCH contains data belonging to only one MBSFN area. An MBSFN area contains one or more MCHs. An MCH specific MCS is used for all subframes of the MCH that do not use the MCS indicated in BCCH. All MCHs have the same coverage area.

For MCCH and MTCH, the UE shall not perform RLC re-establishment at cell change between cells of the same MBSFN area. Within the MBSFN subframes, all MCHs within the same MBSFN area occupy a pattern of subframes, not necessarily adjacent in time, which is common for all these MCHs and is therefore called the common subframe allocation (CSA) pattern. The CSA pattern is periodically repeated with the CSA period. The actual MCH subframe allocation (MSA) for every MCH carrying MTCH is defined by the CSA pattern, the CSA period, and the MSA end, that are all signaled on MCCH. The MSA end indicates the last subframe of the MCH within the CSA period. Consequently, the MCHs are time multiplexed within the CSA period, which finally defines the interleaving degree between the MCHs. It shall be possible for MCHs to not use all MBSFN resources signaled as part of the Rel-8 MBSFN signaling. Further, such MBSFN resource can be shared for more than one purpose (MBMS, positioning, etc.). During one MCH scheduling period (MSP), which is configurable per MCH, the eNB applies MAC multiplexing of different MTCHs and optionally MCCH to be transmitted on this MCH.

MCH scheduling information (MSI) is provided per MCH to indicate which subframes are used by each MTCH during the MSP. The following principles are used for the MSI:
it is used both when services are multiplexed onto the MCH and when only a single service is transmitted on the MCH;
it is generated by the eNB and provided once at the beginning of the MSP;
it has higher scheduling priority than the MCCH and, when needed, it appears first in the PDU;
it allows the receiver to determine what subframes are used by every MTCH, sessions are scheduled in the order in which they are included in the MCCH session list;
it is carried in a MAC control element which cannot be segmented;
it carries the mapping of MTCHs to the subframes of the associated MSP. This mapping is based on the indexing of subframes belonging to one MSP.

The content synchronization for multi-cell transmission is provided by the following principles:

1. All eNBs in a given MBSFN synchronization area have a synchronized radio frame timing such that the radio frames are transmitted at the same time and have the same SFN.

2. All eNBs have the same configuration of RLC/MAC/PHY for each MBMS service, and identical information (e.g. time information, transmission order/priority information) such that synchronized MCH scheduling in the eNBs is ensured. These are indicated in advance by the MCE.

3. An enhanced MBMS (E-MBMS) gateway (GW) sends/broadcasts MBMS packet with the SYNC protocol to each eNB transmitting the service.

4. The SYNC protocol provides additional information so that the eNBs identify the transmission radio frame(s). The E-MBMS GW does not need accurate knowledge of radio resource allocation in terms of exact time division (e.g. exact start time of the radio frame transmission).

5. The eNB buffers MBMS packet and waits for the transmission timing indicated in the SYNC protocol.

6. The segmentation/concatenation is needed for MBMS packets and should be totally up to the RLC/MAC layer in eNB.

7. The SYNC protocol provides means to detect packet loss(es) and supports a recovery mechanism robust against loss of consecutive PDU packets (MBMS packets with SYNC header).

8. For the packet loss case the transmission of radio blocks potentially impacted by the lost packet should be muted.

9. The mechanism supports indication or detection of MBMS data burst termination (e.g. to identify and alternately use available spare resources related to pauses in the MBMS PDU data flow).

10. If two or more consecutive SYNC service data units (SDUs) within a SYNC bearer are not received by the eNB, or if no SYNC PDUs of Type 0 or 3 are received for some synchronization sequence, the eNB may mute the exact subframes impacted by lost SYNC PDUs using information provided by SYNC protocol. If not muting only those exact subframes, the eNB stops transmitting the associated MCH from the subframe corresponding to the consecutive losses until the end of the corresponding MSP and it does not transmit in the subframe corresponding to the MSI of that MSP.

11. The eNB sets VT(US) to zero in the RLC UM entity corresponding to an MCCH at its modification period boundary.

12. The eNB sets VT(US) to zero in each RLC UM entity corresponding to an MTCH at the beginning of its MSP.

13. The eNB sets every bit in the MAC padding on MCH to “0”.

14. The eNB's RLC concatenates as many RLC SDUs from the same radio bearer as possible.

15. The eNB's MAC multiplexes as many RLC PDUs as fit in the transport block.

The following principles govern the MCCH structure:
One MBSFN area is associated with one MCCH and one MCCH corresponds to one MBSFN area;
The MCCH is sent on MCH;
MCCH consists of a single MBSFN area configuration RRC message which lists all the MBMS services with ongoing sessions and an optional MBMS counting request message;
MCCH is transmitted by all cells within an MBSFN area, except the MBSFN area reserved cells;
MCCH is transmitted by RRC every MCCH repetition period;
MCCH uses a modification period;
A notification mechanism is used to announce changes of MCCH due to either session start or the presence of an MBMS counting request message: The notification is sent periodically throughout the modification period preceding the change of MCCH, in MBSFN subframes configured for notification. The downlink control information (DCI) format 1C with MBMS radio network temporary identity (M-RNTI) is used for notification and includes an 8-bit bitmap to indicate the one or more MBSFN area(s) in which the MCCH change(s). The UE monitors more than one notification subframe per modification period. When the UE receives a notification, it acquires the MCCH at the next modification period boundary;
The UE detects changes to MCCH which are not announced by the notification mechanism by MCCH monitoring at the modification period.

In general, the control rmation relevant only for UEs supporting MBMS is separated as much as possible from unicast control rmation. Most of the MBMS control rmation is provided on a logical channel specific for MBMS common control rmation: the MCCH. E-UTRA employs one MCCH logical channel per MBSFN area. In case the network configures multiple MBSFN areas, the UE acquires the MBMS control rmation from the MCCHs that are configured to identify if services it is interested to receive are ongoing. An MBMS capable UE may be only required to support reception of a single MBMS service at a time. The MCCH carries the MBSFNAreaConfiguration message, which indicates the MBMS sessions that are ongoing as well as the (corresponding) radio resource configuration. The MCCH may also carry the MBMSCountingRequest message, when E-UTRAN wishes to count the number of UEs in RRC_CONNECTED that are receiving or interested to receive one or more specific MBMS services.

A limited amount of MBMS control rmation is provided on the BCCH. This primarily concerns the rmation needed to acquire the MCCH(s). This rmation is carried by means of a single MBMS specific SystemInformationBlock: SystemInformationBlockType13. An MBSFN area is identified solely by the mbsfn-AreaId in SystemInformationBlockType13. At mobility, the UE considers that the MBSFN area is continuous when the source cell and the target cell broadcast the same value in the mbsfn-AreaId.

The MCCH rmation is transmitted periodically, using a configurable repetition period. Scheduling rmation is not provided for MCCH, i.e. both the time domain scheduling as well as the lower layer configuration are semi-statically configured, as defined within SystemInformationBlockType13.

For MBMS user data, which is carried by the MTCH logical channel, E-UTRAN periodically provides MSI at lower layers (MAC). This MCH rmation only concerns the time domain scheduling, i.e. the frequency domain scheduling and the lower layer configuration are semi-statically configured. The periodicity of the MSI is configurable and defined by the MCH scheduling period.

Change of MCCH rmation only occurs at specific radio frames, i.e. the concept of a modification period is used. Within a modification period, the same MCCH rmation may be transmitted a number of times, as defined by its scheduling (which is based on a repetition period). The modification period boundaries are defined by system frame number (SFN) values for which SFN mod m=0, where m is the number of radio frames comprising the modification period. The modification period is configured by means of SystemInformationBlockType13.

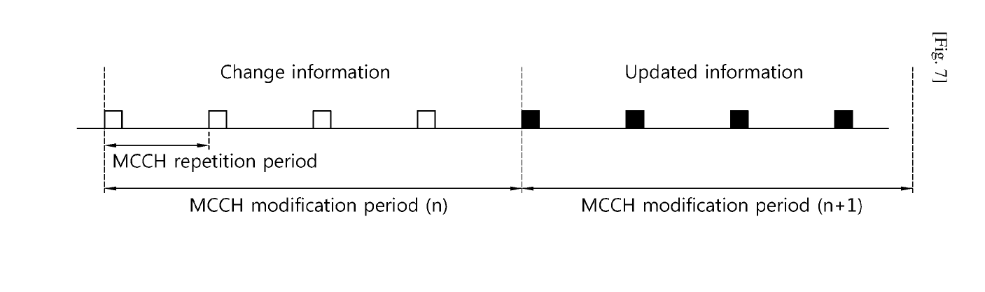

FIG. 7 shows change of MCCH information. When the network changes (some of) the MCCH rmation, it notifies the UEs about the change during a first modification period. In the next modification period, the network transmits the updated MCCH rmation. In FIG. 7, different colors indicate different MCCH information. Upon receiving a change notification, a UE interested to receive MBMS services acquires the new MCCH rmation immediately from the start of the next modification period. The UE applies the previously acquired MCCH rmation until the UE acquires the new MCCH rmation.

Indication of an MBMS specific RNTI, the M-RNTI, on PDCCH is used to rm UEs in RRC_IDLE and UEs in RRC_CONNECTED about an MCCH rmation change. When receiving an MCCH rmation change notification, the UE knows that the MCCH rmation will change at the next modification period boundary. The notification on PDCCH indicates which of the MCCHs will change, which is done by means of an 8-bit bitmap. Within this bitmap, the bit at the position indicated by the field notificationIndicator is used to indicate changes for that MBSFN area: if the bit is set to “1”, the corresponding MCCH will change. No further details are provided, e.g. regarding which MCCH rmation will change. The MCCH rmation change notification is used to rm the UE about a change of MCCH rmation upon session start or about the start of MBMS counting.

The MCCH rmation change notifications on PDCCH are transmitted periodically and are carried on MBSFN subframes only. These MCCH rmation change notification occasions are common for all MCCHs that are configured, and configurable by parameters included in SystemInformationBlockType13: a repetition coefficient, a radio frame offset and a subframe index. These common notification occasions are based on the MCCH with the shortest modification period.

A UE that is receiving an MBMS service shall acquire the MCCH rmation from the start of each modification period. A UE that is not receiving an MBMS service, as well as UEs that are receiving an MBMS service but potentially interested to receive other services not started yet in another MBSFN area, shall verify that the stored MCCH rmation remains valid by attempting to find the MCCH rmation change notification at least notificationRepetitionCoeff times during the modification period of the applicable MCCH(s), if no MCCH rmation change notification is received.

The UE applies the MCCH rmation acquisition procedure to acquire the MBMS control rmation that is broadcasted by the E-UTRAN. The procedure applies to MBMS capable UEs that are in RRC_IDLE or in RRC_CONNECTED.

A UE interested to receive MBMS services shall apply the MCCH rmation acquisition procedure upon entering the corresponding MBSFN area (e.g. upon power on, following UE mobility) and upon receiving a notification that the MCCH rmation has changed. A UE that is receiving an MBMS service shall apply the MCCH rmation acquisition procedure to acquire the MCCH, which corresponds with the service that is being received, at the start of each modification period.

Unless explicitly stated otherwise in the procedural specification, the MCCH rmation acquisition procedure overwrites any stored MCCH rmation, i.e. delta configuration is not applicable for MCCH rmation and the UE discontinues using a field if it is absent in MCCH rmation unless explicitly specified otherwise.

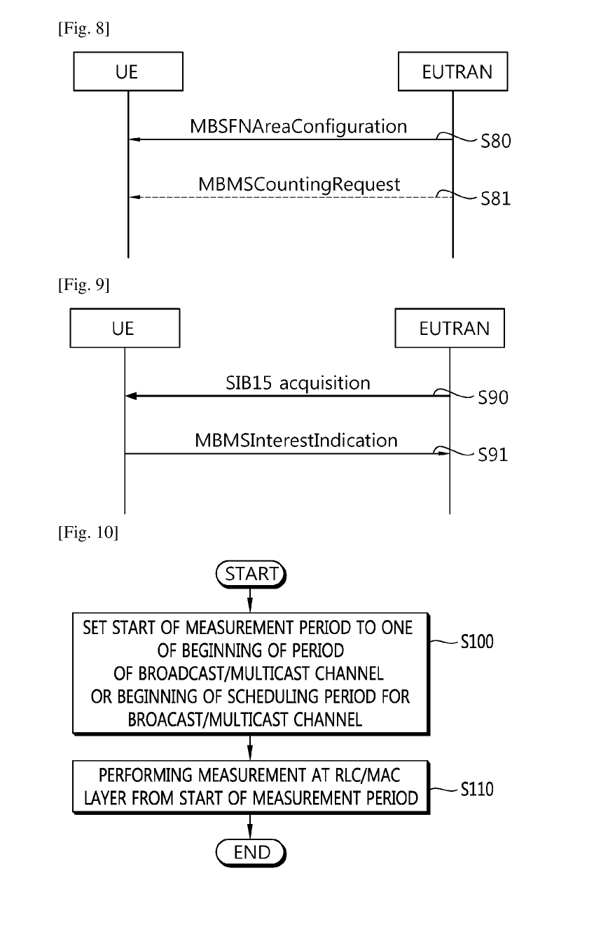

FIG. 8 shows a MCCH information acquisition procedure. An MBMS capable UE shall:

1> if the procedure is triggered by an MCCH rmation change notification:

2> start acquiring the MBSFNAreaConfiguration message (in step S80) and the MBMSCountingRequest message if present (in step S81), from the beginning of the modification period following the one in which the change notification was received;

1> if the UE enters an MBSFN area:

2> acquire the MBSFNAreaConfiguration message (in step S80) and the MBMSCountingRequest message if present (in step S81), at the next repetition period;

1> if the UE is receiving an MBMS service:

2> start acquiring the MBSFNAreaConfiguration message (in step S80) and the MBMSCountingRequest message if present (in step S81), that both concern the MBSFN area of the service that is being received, from the beginning of each modification period;

The MBMS PTM radio bearer (MRB) configuration procedure is used by the UE to configure RLC, MAC and the physical layer upon starting and/or stopping to receive an MRB. The procedure applies to UEs interested to receive one or more MBMS services. The UE applies the MRB establishment procedure to start receiving a session of a service it has an interest in. The procedure may be initiated, e.g. upon start of the MBMS session, upon (re-)entry of the corresponding MBSFN service area, upon becoming interested in the MBMS service, upon removal of UE capability limitations inhibiting reception of the concerned service. The UE applies the MRB release procedure to stop receiving a session. The procedure may be initiated, e.g. upon stop of the MBMS session, upon leaving the corresponding MBSFN service area, upon losing interest in the MBMS service, when capability limitations start inhibiting reception of the concerned service.

The purpose of MBMS interest indication is to inform the E-UTRAN that the UE is receiving or is interested to receive MBMS via an MBMS radio bearer (MRB), and if so, to inform the E-UTRAN about the priority of MBMS versus unicast reception.

FIG. 9 shows an MBMS interest indication procedure. An MBMS capable UE in RRC_CONNECTED may initiate the procedure in several cases including upon successful connection establishment, upon entering or leaving the service area, upon session start or stop, upon change of interest, upon change of priority between MBMS reception and unicast reception or upon change to a primary cell (PCell) broadcasting SystemInformationBlockType15.

Upon initiating the procedure, the UE shall:

1> if SystemInformationBlockType15 is broadcast by the PCell; and has been acquired by the UE (in step S90):

2> if the UE did not transmit an MBMSInterestIndication message since last entering RRC_CONNECTED state; or

2> if since the last time the UE transmitted an MBMSInterestIndication message, the UE connected to a PCell not broadcasting SystemInformationBlockType15:

3> if the set of MBMS frequencies of interest is not empty:

4> initiate the transmission of the MBMSInterestIndication message (in step S91);

2> else:

3> if the set of MBMS frequencies of interest has changed since the last transmission of the MBMSInterestIndication message; or

3> if the prioritization of reception of all indicated MBMS frequencies compared to reception of any of the established unicast bearers has changed since the last transmission of the MBMSInterestIndication message:

4> initiate the transmission of the MBMSInterestIndication message (in step S91);

To determine MBMS frequencies of interest, the UE shall:

1> consider a frequency to be part of the MBMS frequencies of interest if the following conditions are met:

2> if at least one MBMS session the UE is receiving or interested to receive via an MRB is ongoing or about to start; and

2> if for at least one of these MBMS sessions SystemInformationBlockType15 acquired from the PCell includes for the concerned frequency one or more MBMS SAIs as indicated in the USD for this session; and

2> the UE is capable of simultaneously receiving the set of MBMS frequencies of interest, regardless of whether a serving cell is configured on each of these frequencies or not; and

2> the supportedBandCombination the UE included in UE-EUTRA-Capability contains at least one band combination including the set of MBMS frequencies of interest;

The UE shall set the contents of the MBMSInterestIndication message as follows:

1> if the set of MBMS frequencies of interest is not empty:

2> include mbms-FreqList and set it to include the MBMS frequencies of interest;

2> include mbms-Priority if the UE prioritises reception of all indicated MBMS frequencies above reception of any of the unicast bearers;

The UE shall submit the MBMSInterestIndication message to lower layers for transmission.

The PTM communication may include utilizing a dedicated channel or dedicated carrier to broadcast data or services to multiple users. While a certain amount of overhead may be required to initiate a PTM communication, the overhead is relatively small and may not vary in relation to the number of UEs. That is, as more UEs utilize PTM communication, the overhead required to establish and maintain PTM communication remains approximately the same. The PTM communication may also improve spectral efficiency as the number of UEs increases because no new transmissions are required for new added users. In some cases, PTM communication is limited to a single cell, wherein communications are restricted between the eNB and one or more UEs of that cell. Such restricted communication is referred to as single cell PTM (SC-PTM) communication.

Hereinafter, a method for determining a measurement period according to an embodiment of the present invention is described. The UE may measure MBMS service quality for a certain measurement period. However, it is not clear how the UE determines the start/stop of the measurement period.

FIG. 10 shows an example of a method for determining a measurement period according to an embodiment of the present invention.

In step S100, the UE sets the start of the measurement period to one of beginning of a period of a broadcast/multicast control channel or beginning of a scheduling period for the broadcast/multicast channel. If the broadcast/multicast control channel is the MCCH, the period of the broadcast/multicast control may be one of the MCCH modification period or the MCCH repetition period. The scheduling period for the broadcast/multicast channel may be the MSP. If the broadcast/multicast control channel is the BCCH, the period of the broadcast/multicast control may be the BCCH modification period. Alternatively, the start of the measurement period may be set to a time when a RLC PDU including RLC sequence number (SN) set to ‘0’ is received (if the UE starts to receive the MBMS service or is receiving the MBMS service via the MRB).

Corresponding to the start of the measurement period, the end of the measurement period may be set to one of ending of the same MCCH modification period, the same MCCH repetition period, the same MSP, the same BCCH modification period or a time when another RLC PDU including RLC SN set to ‘0’ is received after the RLC PDU including RLC SN set to ‘0’ is received. Alternatively, the end of the measurement period may be set to ending of the MSP right after a number of consecutive MSPs that is configured in the measurement configuration.

Further, before setting the start of the measurement period, the UE may periodically monitor a MCCH for the MBMS service according to a MCCH modification period and a MCCH repetition period. The UE may configure a physical layer, a MAC layer and a RLC layer for a MRB corresponding to the MBMS service by receiving the MBMS configuration via the MCCH. The UE may configure measurement of MBMS service quality by receiving the measurement configuration from the network. The length of the measurement period may be included in the measurement configuration. Further, what to measure for MBMS service quality (e.g. throughput, the number/size of missing/received data units, reference signal received quality (RSRQ), reference signal received power (RSRP), block error ratio (BLER)) may be included in the measurement configuration.

Back to FIG. 10, in step S110, the UE performs, at the RLC layer or at the MAC layer, measurement from the start of the measurement period. The UE may stop measurement at the end of the measurement period. The performing measurement may include measuring one of the number of missing/received RLC SDUs, the size of received RLC SDUs, the number of missing/received RLC PDUs, the size of received RLC PDUs, RSRP, RSRQ, BLER, the number/size of erroneous MAC SDU/PDUs.

The UE may transmit a report message including the measurement result after the end of the measurement period. The report message may correspond to one of the measurement report message, the MBMS interest indication message, or the UE information response message.

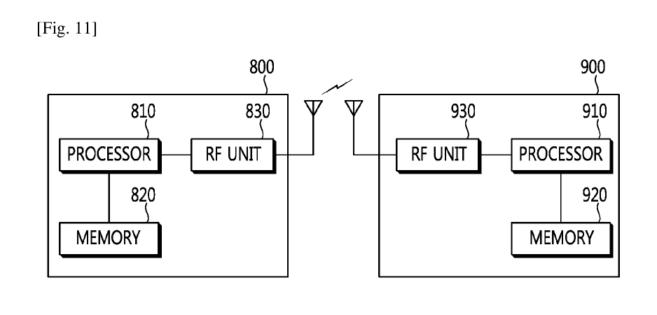

FIG. 11 shows a wireless communication system to implement an embodiment of the present invention.

An eNB 800 may include a processor 810, a memory 820 and a radio frequency (RF) unit 830. The processor 810 may be configured to implement proposed functions, procedures and/or methods described in this description. Layers of the radio interface protocol may be implemented in the processor 810. The memory 820 is operatively coupled with the processor 810 and stores a variety of information to operate the processor 810. The RF unit 830 is operatively coupled with the processor 810, and transmits and/or receives a radio signal.

A UE 900 may include a processor 910, a memory 920 and a RF unit 930. The processor 910 may be configured to implement proposed functions, procedures and/or methods described in this description. Layers of the radio interface protocol may be implemented in the processor 910. The memory 920 is operatively coupled with the processor 910 and stores a variety of information to operate the processor 910. The RF unit 930 is operatively coupled with the processor 910, and transmits and/or receives a radio signal.

The processors 810, 910 may include application-specific integrated circuit (ASIC), other chipset, logic circuit and/or data processing device. The memories 820, 920 may include read-only memory (ROM), random access memory (RAM), flash memory, memory card, storage medium and/or other storage device. The RF units 830, 930 may include baseband circuitry to process radio frequency signals. When the embodiments are implemented in software, the techniques described herein can be implemented with modules (e.g., procedures, functions, and so on) that perform the functions described herein. The modules can be stored in memories 820, 920 and executed by processors 810, 910. The memories 820, 920 can be implemented within the processors 810, 910 or external to the processors 810, 910 in which case those can be communicatively coupled to the processors 810, 910 via various means as is known in the art.

In view of the exemplary systems described herein, methodologies that may be implemented in accordance with the disclosed subject matter have been described with reference to several flow diagrams. While for purposed of simplicity, the methodologies are shown and described as a series of steps or blocks, it is to be understood and appreciated that the claimed subject matter is not limited by the order of the steps or blocks, as some steps may occur in different orders or concurrently with other steps from what is depicted and described herein. Moreover, one skilled in the art would understand that the steps illustrated in the flow diagram are not exclusive and other steps may be included or one or more of the steps in the example flow diagram may be deleted without affecting the scope and spirit of the present disclosure.

1. A method for determining, by a user equipment (UE), a measurement period in a wireless communication system, the method comprising:
setting, by the UE, start of the measurement period to one of beginning of a period of a broadcast/multicast control channel or beginning of a scheduling period for the broadcast/multicast channel; and
performing, by a radio link control (RLC) layer or a media access control (MAC) layer of the UE, measurement from the start of the measurement period.

2. The method of claim 1, wherein the broadcast/multicast control channel is one of a multicast control channel (MCCH) or a broadcast control channel (BCCH).

3. The method of claim 1, wherein the period of the broadcast/multicast control channel is one of a MCCH modification period, a MCCH repetition period or a BCCH modification period.

4. The method of claim 1, wherein the scheduling period for the broadcast/multicast channel is a multicast channel (MCH) scheduling period (MSP).

5. The method of claim 1, wherein the measurement period ends at one of ending of the period of a broadcast/multicast control channel or ending of the scheduling period for the broadcast/multicast channel.

6. The method of claim 1, wherein performing the measurement includes measuring at least one of a number of missing or received radio link control (RLC) service data units (SDUs), a size of received RLC SDUs, a number of missing or received RLC protocol data units (PDUs), a size of received RLC PDUs, a reference signal received power (RSRP), a reference signal received quality (RSRQ), a block error ratio (BLER), or a number/size of erroneous media access control (MAC) SDUs or PDUs.

7. The method of claim 1, further comprising periodically monitoring the multicast/broadcast control channel for a service.

8. The method of claim 7, wherein the service is a multimedia broadcast multicast service (MBMS).

9. The method of claim 1, further comprising receiving a configuration for a service via the multicast/broadcast control channel from a network.

10. The method of claim 1, further comprising receiving a configuration for the measurement from a network.

11. The method of claim 10, wherein the configuration for the measurement includes a length of the measurement period.

12. The method of claim 10, wherein the configuration for the measurement includes what to measure for service quality.

13. The method of claim 1, further transmitting a report message including the measurement result to a network.

14. The method of claim 13, wherein the report message corresponds to one of a measurement report message, a MBMS interest indication message or a UE information response message.

15. A user equipment (UE) configured to determine a measurement period in a wireless communication system, the UE comprising:
a radio frequency (RF) unit configured to transmit or receive a radio signal; and
a processor coupled to the RF unit, and configured to:
set start of the measurement period to one of beginning of a period of a broadcast/multicast control channel or beginning of a scheduling period for the broadcast/multicast channel; and
perform, at a radio link control (RLC) layer or a media access control (MAC) layer of the UE, measurement from the start of the measurement period.
